(19) United States
(12) Patent Application Publication
(10) Pub. No.: US 2009/0276499 A1
(43) Pub. Date: Nov. 5, 2009

(54) INTERWORKING METHOD FOR MESSAGE SYSTEMS AND MESSAGE INTERWORKING GATEWAY

(75) Inventor: Lunjian MU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/487,042

(22) Filed: Jun. 18, 2009

Related U.S. Application Data
(63) Continuation of application No. PCT/CN2007/070568, filed on Aug. 27, 2007.

(30) Foreign Application Priority Data
Dec. 19, 2006 (CN) 200610161745.1

(51) Int. Cl. G06F 15/16

(52) U.S. Cl. 709/206; 709/230; 709/230

(57) ABSTRACT

An interworking method for message systems and a message interworking gateway are provided. When a session initiation protocol (SIP) message system sends a message to a non-SIP message system, the message is first sent to the message interworking gateway through a message session relay protocol (MSRP) channel established between the SIP message system and the message interworking gateway, and then sent to the non-SIP message system by the message interworking gateway. Further, when the non-SIP message system sends a message to the SIP message system, the message is first sent to the message interworking gateway, and then sent to the SIP message system through the MSRP channel by the message interworking gateway. As the MSRP channel established between the SIP message system and the message interworking gateway may transmit large or small messages, the method of interworking message systems and the message interworking gateway provided by embodiments of the present invention may be adopted to achieve the interworking between the SIP message system and the non-SIP message system.

### CROSS-REFERENCE TO RELATED APPLICATIONS

This application is a continuation of International Patent Application No. PCT/CN2007/070568, filed Aug. 27, 2007, which claims priority to Chinese Patent Application No. 200610161745.1, filed Dec. 19, 2006, both of which are hereby incorporated by reference in their entirety.

### FIELD OF THE TECHNOLOGY

The present invention relates to the technical field of network communication, and in particular to an interworking method for message systems and a message interworking gateway.

### BACKGROUND

Based on the international standards such as Open Mobile Alliance (OMA), 3rd-Generation Partnership Project (3GPP) and 3GPP2, message services may be divided into session initiation protocol (SIP) based message services and non-SIP-based message services. The SIP-based message services, such as instant messaging (IM) over session initiation protocol for instant messaging and presence leveraging extensions (SIMPLE), push-to-talk over cellular (PoC) and converged IP messaging (CPM), are mainly adapted for the next-generation network (NGN) based on the IP multimedia sub-system (IMS). The non-SIP-based message services, such as wireless village (WV) services, email services and multimedia messaging service (MMS), are mainly adapted for conventional communication networks.

The SIP-based message services are processed by an SIP message system adapting SIP as the signaling bearer. Subscribers of the SIP message system intercommunicate through, for example, an SIMPLE IM server, a PoC server or a CPM server. The non-SIP-based message services are processed by a non-SIP message system adapting a non-SIP as the signaling bearer. Subscribers of the non-SIP message system intercommunicate through, for example, a WV server, an email server or an MMS.

In the conventional art, in order to achieve intercommunication between subscribers of the SIP message system and subscribers of the non-SIP message system, a message interworking gateway is added between the SIP message system and the non-SIP message system. When a subscriber of the SIP message system sends a message to a subscriber of the non-SIP message system, the SIP message system makes use of an SIP MESSAGE to carry the message, and sends the SIP MESSAGE carrying the message to the message interworking gateway. After receiving the SIP MESSAGE, the message interworking gateway makes use of the SIP MESSAGE to configure a message of the non-SIP message system, and then sends the message of the non-SIP message system to the corresponding non-SIP message system. When a subscriber of the non-SIP message system sends a message to a subscriber of the SIP message system, the non-SIP message system sends the message to the message interworking gateway. After receiving the message, the message interworking gateway makes use of the message to configure an SIP MESSAGE of the SIP message system, and then sends the SIP MESSAGE to the SIP message system.

In the above conventional art, the prerequisite of adopting the SIP MESSAGE of the SIP message system to carry a message is that the carried message is small, i.e., the size of the message does not exceed a carrying capacity of the SIP MESSAGE. Only for these small messages, the implementation of the SIP MESSAGE to carry a message in the conventional art may be achieved. However, when the SIP MESSAGE cannot carry the message, the conventional art may not send the message from the subscriber of the SIP message system to the subscriber of the non-SIP message system.

Therefore, the conventional art cannot completely achieve the intercommunication between a subscriber of the SIP message system and a subscriber of the non-SIP message system, i.e., fail to completely achieve the interworking between the SIP message system and the non-SIP message system.

### SUMMARY

Accordingly, the present invention provides an interworking method for message systems in an embodiment so as to achieve the interworking between an SIP message system and a non-SIP message system.

The present invention provides another interworking method for message systems in an embodiment so as to achieve the interworking between an SIP message system and a non-SIP message system.

The present invention also provides a message interworking gateway in an embodiment so as to achieve the interworking between an SIP message system and a non-SIP message system.

The present invention provides another message interworking gateway in an embodiment so as to achieve the interworking between an SIP message system and a non-SIP message system.

An interworking method for message systems includes the following steps.

A message session relay protocol (MSRP) channel with a session initiation protocol (SIP) message system is established. An MSRP message sent by the SIP message system is received through the MSRP channel. The MSRP message is converted to a non-SIP message. The non-SIP message is sent to a non-SIP message system.

Another interworking method for message systems includes the following steps.

A non-SIP message sent by a non-SIP message system is received. An MSRP channel with an SIP message system is established. The non-SIP message is converted to an MSRP message. The MSRP message is sent to the SIP message system through the MSRP channel.

A message interworking gateway includes a module configured to establish a message session relay protocol (MSRP) channel with a session initiation protocol (SIP) message system; a module configured to receive an MSRP message sent by the SIP message system through the MSRP channel; a module configured to convert the MSRP message to a non-SIP message; and a module configured to send the non-SIP message to a non-SIP message system.

Another message interworking gateway includes a module configured to establish an MSRP channel with an SIP message system; a module configured to receive a non-SIP message sent by a non-SIP message system; a module configured to covert the non-SIP message to an MSRP message; and a module configured to send the MSRP message to the SIP message system through the MSRP channel.

With the interworking method for message systems and the message interworking gateway provided by embodiments of the present invention, under the condition of an SIP message system sending a message to a non-SIP message system, the message is first sent to the message interworking gateway through an MSRP channel established between the SIP message system and the message interworking gateway, and then sent to the non-SIP message system by the message interworking gateway. Further, under the condition of the non-SIP message system sending a message to the SIP message system, the message is first sent to the message interworking gateway, and then sent to the SIP message system through the MSRP channel by the message interworking gateway. As the MSRP channel established between the SIP message system and the message interworking gateway is capable of transmitting large or small messages, the message interworking gateway, the interworking method and system for message systems provided by the present invention may achieve the interworking between the SIP message system and the non-SIP message system.

### BRIEF DESCRIPTION OF THE DRAWINGS

FIG. 1 is a schematic structural view of an interworking system according to an embodiment of the present invention;

FIG. 2 is a flow chart illustrating processes of an SIP message system sending a message to a non-SIP message system according to an embodiment of the present invention;

FIG. 3 is a flow chart illustrating processes of a non-SIP message system sending a message to an SIP message system according to an embodiment of the present invention;

FIG. 4 is a signaling flow chart of Embodiment 1 of the present invention;

FIG. 5 is a signaling flow chart of Embodiment 2 of the present invention;

FIG. 6 is a signaling flow chart of Embodiment 3 of the present invention;

FIG. 7 is a signaling flow chart of Embodiment 4 of the present invention;

FIG. 8 is a signaling flow chart of Embodiment 5 of the present invention;

FIG. 9 is a signaling flow chart of Embodiment 6 of the present invention;

FIG. 10 is a signaling flow chart of Embodiment 7 of the present invention; and

FIG. 11 is a signaling flow chart of Embodiment 8 of the present invention.

### DETAILED DESCRIPTION

Technical solutions in embodiments of the present invention are illustrated in detail below with reference to the accompanying drawings.

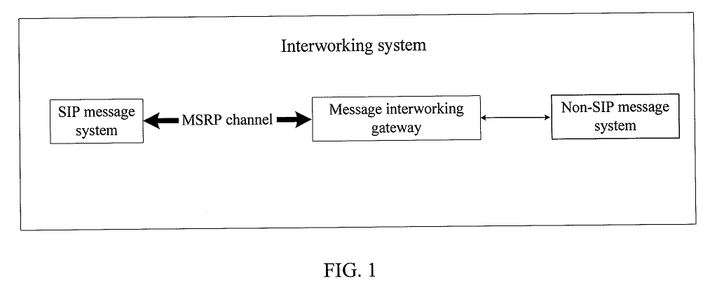

In an embodiment of the present invention, an interworking system is provided. FIG. 1 is a schematic structural view of this system. The system includes an SIP message system, a non-SIP message system and a message interworking gateway. Wherein, the message interworking gateway is capable of sending a message sent by the SIP message system to the non-SIP message system through an MSRP channel established between the SIP message system and the message interworking gateway, and sending a message sent by the non-SIP message system to the SIP message system through the MSRP channel.

In an embodiment of the present invention, an interworking method for message systems is provided, which includes the following steps. An MSRP channel with an SIP message system is established. An MSRP message sent by the SIP message system is received through the MSRP channel. The MSRP message is converted to a non-SIP message. The non-SIP message is sent to a non-SIP message system. Thus, this method achieves the sending of a message from an SIP message system to a non-SIP message system.

In an embodiment of the present invention, a message interworking gateway based on the above interworking method for message systems is also provided, and may be disposed in the system of FIG. 1. The message interworking gateway includes a module for establishing an MSRP channel with an SIP message system; a module for receiving an MSRP message sent by the SIP message system through the MSRP channel; a module for converting the MSRP message to a non-SIP message and a module for sending the non-SIP message to a non-SIP message system.

In an embodiment of the present invention, another interworking method for message systems is provided, which includes the following steps. A non-SIP message sent by a non-SIP message system is received. An MSRP channel with an SIP message system is established. The non-SIP message is converted to an MSRP message. The MSRP message is sent to the SIP message system through the MSRP channel. Thus, this method achieves the sending of a message from a non-SIP message system to an SIP message system.

In an embodiment of the present invention, another message interworking gateway based on the above interworking method for message systems is also provided, and may be disposed in the system of FIG. 1. The message interworking gateway includes a module to establish an MSRP channel with an SIP message system; a module to receive a non-SIP message sent by a non-SIP message system; a module to convert the non-SIP message to an MSRP message and a module to send the MSRP message to the SIP message system through the MSRP channel.

Further, in the embodiments of the present invention, both the SIP message system and the non-SIP message system may include a message server and a message client.

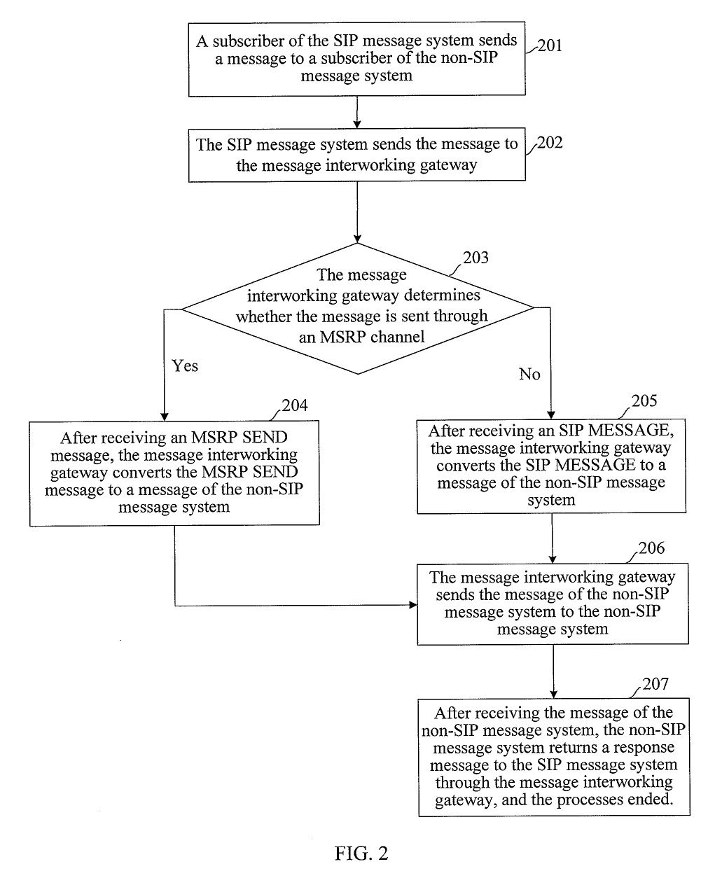

Referring to FIG. 2, a flow chart illustrating processes of an SIP message system sending a message to a non-SIP message system according to an embodiment of the present invention is shown, which includes the following steps.

In Step 201, a subscriber of the SIP message system sends a message to a subscriber of the non-SIP message system.

In Step 202, the SIP message system sends the message to the message interworking gateway.

In Step 203, after receiving the message, the message interworking gateway determines whether the message is sent through an MSRP channel. If the message is sent through an MSRP channel, Step 204 is performed. Otherwise, Step 205 is performed.

In the above step, the message interworking gateway determines whether the received message is sent through an MSRP channel according to the type of the received message. If the message received by the message interworking gateway is an MSRP SEND message, the message interworking gateway determines that the message is sent through an MSRP channel. If the message received by the message interworking gateway is an SIP MESSAGE, the message interworking gateway determines that the message is not sent through an MSRP channel.

In Step 204, on receiving the MSRP SEND message, the message interworking gateway converts the message to a message of the non-SIP message system; and then Step 206 is performed.

In the above step, the MSRP SEND message carries information such as message content and message type sent by the subscriber of the SIP message system to the subscriber of the non-SIP message system. The message interworking gateway fills the information into the message of the non-SIP message system to convert the MSRP SEND message to a message of the non-SIP message system. In this embodiment, the message interworking gateway is capable of parsing the MSRP SEND message.

In Step 205, on receiving the SIP MESSAGE, the message interworking gateway converts the SIP MESSAGE to a message of the non-SIP message system.

In the above step, it is a conventional function of the message interworking gateway converting the SIP MESSAGE to a message of the non-SIP message system.

In Step 206, the message interworking gateway sends the message of the non-SIP message system to the non-SIP message system.

In Step 207, after receiving the message of the non-SIP message system, the non-SIP message system returns a response message to the SIP message system through the message interworking gateway, and the processes end.

The above Step 203 is optional. That is, if the SIP message system sends all the messages through the MSRP channel in spite of the sizes of the messages, Step 203 is unnecessary, and accordingly Step 205 may be skipped.

In the above Step 202, if the SIP message system sends the message to the message interworking gateway through an MSRP channel, an MSRP channel needs to be established between the SIP message system and the message interworking gateway in Step 202. A method of establishing an MSRP channel between the SIP message system and the message interworking gateway is given below. The SIP message system sends an SIP INVITE message for establishing an MSRP channel with the message interworking gateway. On receiving the message, the message interworking gateway confirms its function of establishing an MSRP channel, and returns to the SIP message system a response message agreeing to establish an MSRP channel. In this method, an MSRP channel is established between the SIP message system and the message interworking gateway. Both the above SIP INVITE and the above response message may carry session description protocol (SDP) parameters for establishing an MSRP channel. After adapting the MSRP channel between the SIP message system and the message interworking gateway, the MSRP channel may be saved for a period of time during which the MSRP channel may be adapted repetitively. In order to save the transmission resources effectively, after adapting the MSRP channel, the SIP message system may send a request message for disconnecting the MSRP channel to the message interworking gateway. After receiving the request message, the message interworking gateway returns a response agreeing to disconnect the MSRP channel, and thus releases the MSRP channel to the SIP message system.

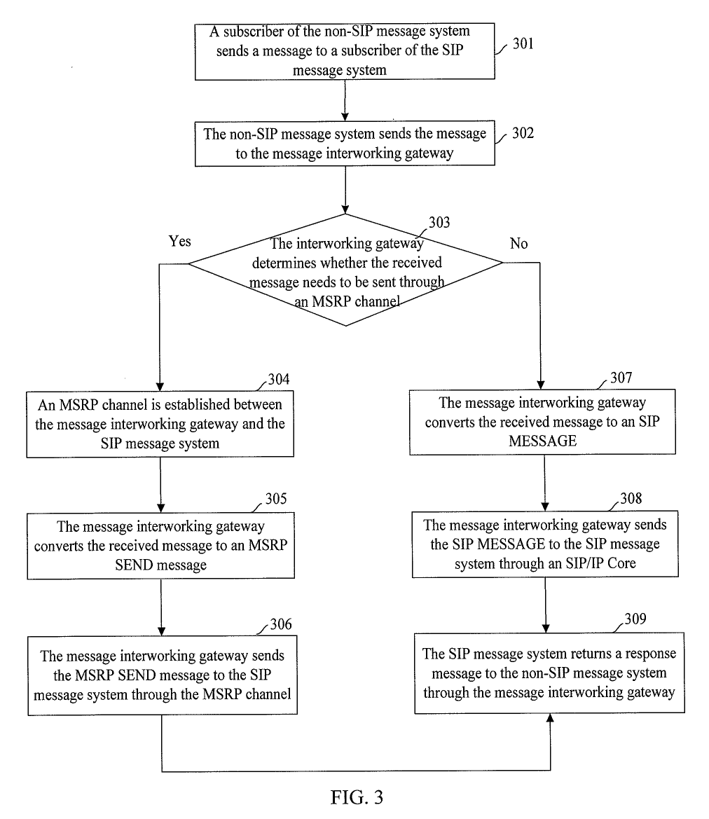

FIG. 3 shows that a flow chart illustrating processes of a non-SIP message system sending a message to an SIP message system according to an embodiment of the present invention, which includes the following steps.

In Step 301, a subscriber of the non-SIP message system sends a message to a subscriber of the SIP message system.

In Step 302, the non-SIP message system sends the message to the message interworking gateway.

In Step 303, after receiving the message, the message interworking gateway determines whether the message needs to be sent through the MSRP channel established between the SIP message system and the message interworking gateway. If the message needs to be sent through the MSRP channel established between the SIP message system and the message interworking gateway, Step 304 is performed. Otherwise, Step 307 is performed.

In the above step, the message interworking gateway determines whether the message needs to be sent through the MSRP channel between the SIP message system and the message interworking gateway by determining whether the size of the message exceeds the carrying capacity of the SIP MESSAGE. If the size of the message exceeds the carrying capacity of the SIP MESSAGE, the message needs to be sent through an MSRP channel. Otherwise, the message may be carried by the SIP MESSAGE. The message interworking gateway may determine whether the size of the message exceeds the carrying capacity of an SIP MESSAGE in the following manners: whether the size of the message exceeds 1300 bytes, set by the SIP, or exceeds MTU-200, or exceeds the size of a message that may be indeed sent successfully by the SIP message system. If the size of the message exceeds 1300 bytes, MTU-200 or the size of a message that may be indeed sent successfully by the SIP message system, the message interworking gateway determines that the SIP MESSAGE may not carry the message. Otherwise, the SIP MESSAGE may be adopted to carry the message. In this embodiment, the message interworking gateway is capable of determining whether the size of a message exceeds the carrying capacity of an SIP MESSAGE.

In Step 304, an MSRP channel between the message interworking gateway and the SIP message system is established.

In the above step, the MSRP channel may be established in the following manner. The message interworking gateway sends an SIP INVITE message for establishing an MSRP channel to the SIP message system; and after receiving the SIP INVITE message, the SIP message system returns a response message agreeing to establish an MSRP channel to the message interworking gateway. Both the SIP INVITE message and the response message returned by the SIP message system may carry SDP parameters negotiated by the message interworking gateway and the SIP message system.

In Step 305, the message interworking gateway converting the received message to an MSRP SEND message.

In the above step, the MSRP SEND message is a message of the SIP message system. The message interworking gateway fills the received information such as the message content and message type into the MSRP SEND message to configure the MSRP SEND message, i.e., to convert the message to the MSRP SEND message.

In Step 306, the message interworking gateway sends the MSRP SEND message to the SIP message system through the MSRP channel, and then Step 309 is performed.

In Step 307, the message interworking gateway converts the received message to an SIP MESSAGE.

In Step 308, the message interworking gateway sends the SIP MESSAGE to the SIP message system through an SIP/IP Core.

The implementations of Steps 307 and 308 are identical to the conventional art.

In Step 309, the SIP message system returns a response message to the non-SIP message system through the message interworking gateway, and the processes end.

The above Step 303 is optional depending on a predetermined message sending strategy. That is, if the message interworking gateway is set to send all the messages to the SIP message system through the MSRP channel, Step 303 is unnecessary, and accordingly Steps 307 and 308 may be skipped. Otherwise; if the message interworking gateway is not set to send the messages to the SIP message system through the MSRP channel, or is set to send not all the messages through the MSRP channel, Step 303 is performed.

In this embodiment, after adapting the MSRP channel between the SIP message system and the message interworking gateway, the MSRP channel may be saved for a period of time during which the MSRP channel may be adapted repetitively. In order to save the transmission resources effectively, after adapting the MSRP channel, the message interworking gateway may send a request message for disconnecting the MSRP channel to the SIP message system. After receiving the request message, the SIP message system returns a response agreeing to disconnect the MSRP channel to the message interworking gateway, and thus releases the MSRP channel.

Hereinafter, eight specific embodiments are described for illustrating the above two embodiments of the present invention.

In Embodiments 1 to 4, assuming the non-SIP message system is a WV message system, Embodiments 1 to 4 are as examples that the WV message system interconnects with the SIP message system. Wherein a subscriber 1 of the WV message system is set to be user1@IMPS.com and a subscriber 2 of the SIP message system is set to be user2@simple.com.

In Embodiment 1, the subscriber 1 of the WV message system sends a message to the subscriber 2 of the SIP message system, and the message is assumed to be small.

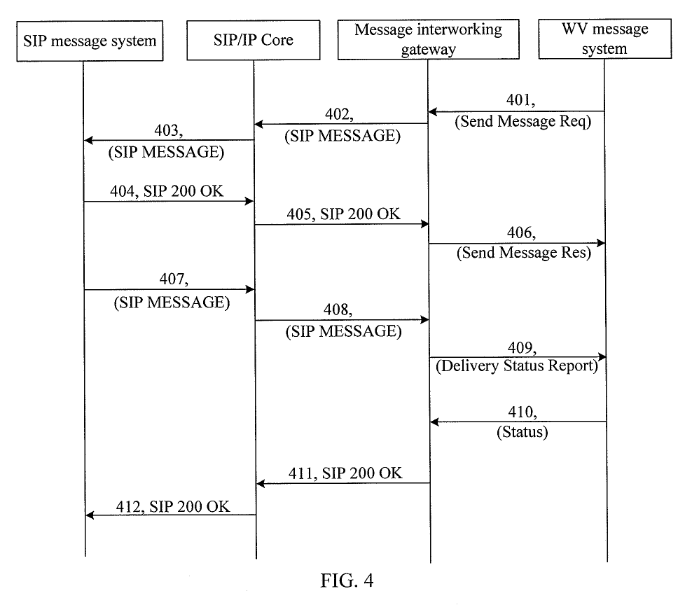

FIG. 4 is a signaling flow chart of Embodiment 1, which includes the following steps.

In Step 401, the WV message system sends a Send Message Request message over a server-server protocol (SSP) to the message interworking gateway.

In the above step, after determining the subscriber 2 for receiving the message belongs to the SIP message system, the WV message system converts a Send Message Request message over a client-server protocol (CSP) to a Send Message Request message over the SSP, and sends the message to the message interworking gateway through hypertext transfer protocol (HTTP).

In the above step, the subscriber 1 is assumed to have requested a delivery report.

In Steps 402 to 403, the message interworking gateway converts the received Send Message Request over the SSP to an SIP MESSAGE, and sends the SIP MESSAGE to the SIP message system through an SIP/IP Core.

In the above step, the message interworking gateway first determines whether the message contained in the Send Message Request to be sent to the subscriber 2 may be carried by the SIP MESSAGE. After determining the size of the message contained in the Send Message Request to be sent to the subscriber 2 does not exceed the carrying capacity of the SIP MESSAGE, the message interworking gateway fills the information such as the sender, receiver, message content and delivery report request contained in the Send Message Request into the SIP MESSAGE to convert the Send Message Request to an SIP MESSAGE. In practice, the message interworking gateway may convert the Send Message Request to the SIP MESSAGE adapting the following code:

```
  POST 10.164.5.254:8080 HTTP/1.1
  ...
```

Content-Type: application/vnd.wv.ssp.xml

```
  Content-Length: 693
  <WV-SSP-Message
```

xmlns=″http://www.openmobilealliance.org/DTD/WV-SSP1.3″>

<Session sessionID=″d432fa84b4c76e66710@IMPS.com″>
<Transaction mode=″Request″ transactionID=″45″>

<SEND message-Request DeliveryReport = ″T″>

<MetaInfo clientOriginated=″Yes″>

<Requestor>

<User userID=″wv:user1@imps.com″>
</User>

</Requestor>

</MetaInfo>

<MessageInfo messageID = 12339sdqwer contentType =

“text/plain” contentSize = 18>

<Recipient>

<User><UserID>sip:user2@simple.com</UserID></User

>

</Recipient>

<Sender>

<User>

<UserID> wv:user1@imps.com</UserID>
</User>

</Sender>

```
  </MessageInfo>
  <ContentData>
```

Watson, come here.

```
  </ContentData>
</SEND message-Request>
  </Transaction>
</Session>
```

</WV-SSP-Message>

MESSAGE sip:user2@simple.com SIP/2.0
Via: SIP/2.0/TCP iwf.com; branch=z9hG4bK776sgdkse
Max-Forwards: 70
From: wv:user1@imps.com;tag=49583
To: sip:user2@simple.com
Call-ID: 12339sdqwer@1.2.3.4
CSeq: 1 MESSAGE
......
imdn.Message-ID: 12339sdqwer
imdn.Disposition-Notification: positive-delivery
Content-Type: text/plain
Content-Length: 18
Watson, come here.

In Steps 404 to 405, after receiving the SIP MESSAGE, the SIP message system returns an SIP 200 OK response to the message interworking gateway through the SIP/IP Core.

In Step 406, the message interworking gateway converts the SIP 200 OK to a Send Message Response message over the SSP, and sends the message to the WV message system through HTTP.

In Steps 407 to 412, the SIP message system sends a delivery status report to the WV message system through the SIP/IP Core and the message interworking gateway. The WV message system returns a response of receiving the report to the SIP message system.

Till then, the process of the WV message system sending a small message to the SIP message system is ended. This embodiment makes use of the SIP MESSAGE to carry the message to be sent to the subscriber 2 based on a conventional signaling flow of the WV message system sending a small message to the SIP message system. Further, the difference from the conventional signaling flow is that, in Step 402 of this embodiment, on receiving the Send Message Request, the message interworking gateway determines whether the size of the message contained in the request to be sent to the subscriber 2 exceeds the carrying capacity of the SIP MESSAGE, and adopts the SIP MESSAGE to carry the message after determining that the size of the message does not exceed the carrying capacity of the SIP MESSAGE. In this embodiment, the message interworking gateway is added with the function of determining whether the size of a message exceeds the carrying capacity of the SIP MESSAGE so as to overcome the defect in the conventional art that only the SIP MESSAGE is adopted to carry a message without considering whether the SIP MESSAGE is capable of carrying the message. Therefore, compared with the conventional art, this embodiment ensures the subscriber 1 to send a message to the subscriber 2 successfully, and avoids the failure of sending the message to the subscriber 2 resulting from the size of the message exceeding the carrying capacity of the SIP MESSAGE.

In Embodiment 2, the subscriber 1 of the WV message system sends a message to the subscriber 2 of the SIP message system, and the message is assumed to be large.

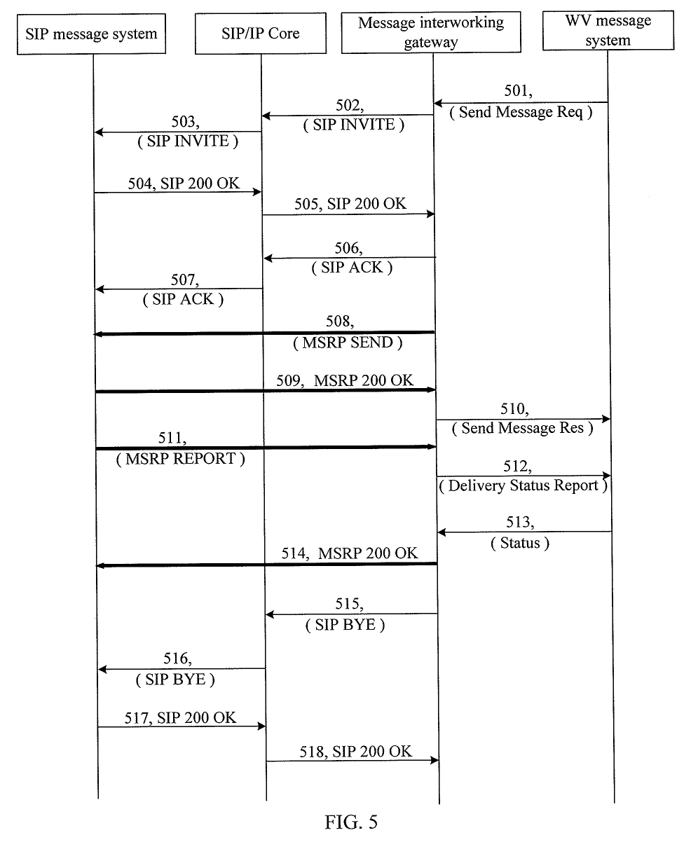

FIG. 5 is a signaling flow chart of Embodiment 2, which includes the following steps.

The description of Step 501 is identical to that of Step 401.

In Steps 502 to 503, the message interworking gateway sends an SIP INVITE message requesting to establish an MSRP channel to the SIP message system through an SIP/IP Core.

In this embodiment, after receiving the Send Message Request over the SSP, the message interworking gateway determines that the size of the message contained in the Send Message Request message to be sent to the subscriber 2 exceeds the carrying capacity of the SIP MESSAGE, and thus the message needs to be sent to the subscriber 2 through the MSRP channel.

In this embodiment, the message interworking gateway fills the information such as the sender and receiver of the message contained in the Send Message Request into the SIP INVITE message to convert the Send Message Request to an SIP INVITE message. The SIP INVITE message carries the SDP parameters for establishing an MSRP channel. In practice, the message interworking gateway converts the Send Message Request to an SIP INVITE message adapting the following code:

POST 10.164.5.254:8080 HTTP/1.1
...

Content-Type: application/vnd.wv.ssp.xml

```
  Content-Length: 693
  <WV-SSP-Message
```

xmlns=″http://www.openmobilealliance.org/DTD/WV-SSP1.3″>

<Session sessionID=″d432fa84b4c76e66710@IMPS.com″>
<Transaction mode=″Request″ transactionID=″45″>

<SEND message-Request DeliveryReport = ″T″>

<MetaInfo clientOriginated=″Yes″>

<Requestor>

<User userID=″wv:user1@imps.com″>
</User>

</Requestor>

</MetaInfo>

<MessageInfo messageID = 12339sdqwer contentType =

“image/jpeg” contentSize =2400>

<Recipient>

<User><UserID>sip:user2@simple.com</UserID></User

>

</Recipient>

<Sender>

<User>

<UserID> wv:user1@imps.com</UserID>
</User>

</Sender>

</MessageInfo>
<ContentData>

................

</ContentData>

</SEND message-Request>

</Transaction>

</Session>

</WV-SSP-Message>

INVITE sip:user2@simple.com SIP/2.0
Via: SIP/2.0/TCP iwf.com; branch=z9hG4bK776sgdkse
Max-Forwards: 70
From: wv:user1@imps.com;tag=49583
To: sip:user2@simple.com
Call-ID: 12339sdqwer@1.2.3.4
CSeq: 1 INVITE
......
Content-Type: application/sdp
(SDP ignored)

In Steps 504 to 507, after receiving the SIP INVITE message and a response agreeing to receive the SIP INVITE message from the subscriber 2, the SIP message system returns an SIP 200 OK response to the message interworking gateway through the SIP/IP Core, and then the message interworking gateway returns an SIP ACK message to the SIP message system through the SIP/IP Core as a response of receiving the SIP 200 OK.

In Step 508, the message interworking gateway converts the received Send Message Request message to an MSRP SEND message, and sends the MSRP SEND message to the SIP message system through the MSRP channel.

In this embodiment, the message interworking gateway fills the information such as the message content and delivery report request contained in the Send Message Request into the MSRP SEND message to convert the Send Message Request to an MSRP SEND message, and sends the MSRP SEND message through the established MSRP channel. In practice, the message interworking gateway converts the Send Message Request message to an MSRP SEND message adapting the following codes:

MSRP d93kswow SEND
To-Path:msrp://user2.simple.com:8888/9di4ea;tcp
From-Path:msrp://user1.imps.com:7777/iau39;tcp
Message-ID: 12339sdqwer
Success-Report: yes
Content-Type: image/jpeg
......
-------d93kswow$

In Step 509, after receiving the MSRP SEND message, the SIP message system returns an MSRP 200 OK response to the message interworking gateway through the MSRP channel.

In practice, if the message sent to the subscriber 2 is too large, and may not be sent to the SIP message system through one MSRP SEND message, the message interworking gateway may convert the message to at least two MSRP SEND messages. Then, Steps 508 to 509 are re-performed till all the MSRP SEND messages are sent to the SIP message system.

In Step 510, after receiving the MSRP 200 OK returned by the SIP message system, the message interworking gateway returns a Send Message Response message over the SSP to the WV message system.

In Step 511, after receiving a Delivery Status Report, the SIP message system sends a delivery report of MSRP REPORT to the message interworking gateway.

In Step 512, the message interworking gateway converts the received delivery report of MSRP REPORT to a Delivery Status Report over the SSP, and sends the Delivery Status Report to the WV message system.

In Step 513, after receiving the Delivery Status Report, the WV message system returns a Status response to the message interworking gateway.

In Step 514, after receiving the Status response, the message interworking gateway returns an MSRP 200 OK to the SIP message system as a response of receiving the MSRP REPORT.

In Steps 515 to 516, the message interworking gateway sends an SIP BYE message requesting to disconnect the MSRP channel to the SIP message system through the SIP/IP Core.

In the above step, the message interworking gateway sends the SIP BYE to a home SIP message server in the SIP message system of the subscriber 2.

In Steps 517 to 518, after receiving the SIP BYE, the SIP message server sends an SIP 200 OK to the message interworking gateway through the SIP/IP Core, and the processes end.

The above Steps 515 to 518 is a signaling flow of the message interworking gateway requesting the SIP/IP Core to disconnect the MSRP channel so as to reduce the waste of resources. In practice, in order to maintain the MSRP channel for a period of time, Steps 515 to 518 may be not performed immediately. That is, the signaling flow of disconnecting the MSRP channel may be actuated after a predetermined period of time such that the MSRP channel may be repetitively adopted during this predetermined period of time.

In Embodiment 3, the subscriber 2 of the SIP message system sends a message to the subscriber 1 of the WV message system, and the message is assumed to be small.

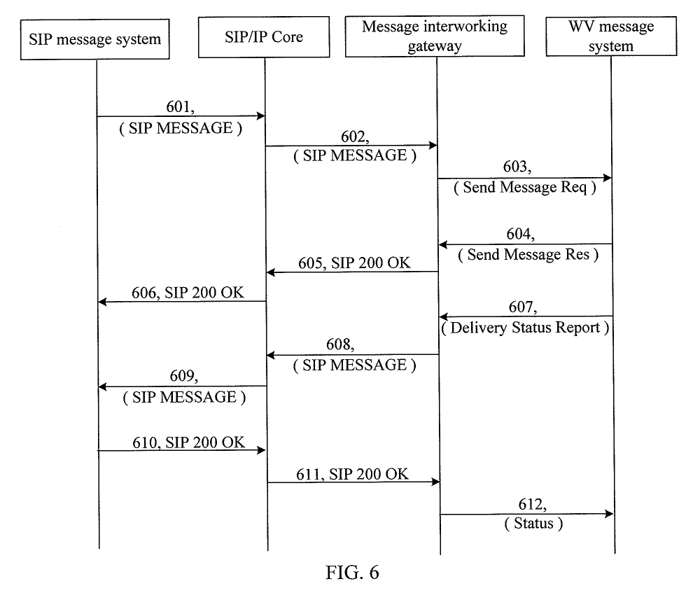

FIG. 6 is a signaling flow chart of Embodiment 3, which includes the following steps.

In Steps 601 to 602, the SIP message system sends the SIP MEAASGE containing the message to be sent to the subscriber 1 to the message interworking gateway through an SIP/IP Core.

In the above step, the SIP message system determines the subscriber 1 for receiving the message belongs to the WV message system, and sends the SIP MEAASGE to the message interworking gateway. The subscriber 1 is assumed to request a delivery report.

In Step 603, after receiving the SIP MEAASGE, the message interworking gateway converts the SIP MESSAGE to a Send Message Request over the SSP type in the WV message system, and sends the Send Message Request to the WV message system through the HTTP.

In this embodiment, after receiving the message forwarded by the SIP message system through the SIP/IP Core, the message interworking gateway determines whether the message is sent through the MSRP channel. When it is determined that the message is the SIP MEAASGE, the message interworking gateway determines that the message is not sent through the MSRP channel. In the above step, the Send Message Request carries the information such as the sender, receiver, message content and delivery report request to be sent to the subscriber 1.

In the conventional art, the message received by the message interworking gateway through the SIP/IP Core is generally defaulted as an SIP MESSAGE for carrying other messages.

In Step 604, on the receiving the Send Message Request message over the SSP type, the WV message system returns the Send Message Response message over the SSP to the message interworking gateway.

In Steps 605 to 606, the message interworking gateway converts the Send Message Response over the SSP to an SIP 200 OK, and sends the SIP 200 OK to the SIP message system through the SIP/IP Core.

In Step 607, after receiving a delivery report notification, the WV message system sends a Delivery Status Report over the SSP to the message interworking gateway.

In Steps 608 to 609, the message interworking gateway converts the Delivery Status Report over the SSP to a delivery report notification of the SIP MESSAGE, and sends the delivery report notification to the SIP message system through the SIP/IP Core.

In Steps 610 to 612, after receiving the delivery report notification, the SIP message system returns an SIP 200 OK response to the message interworking gateway through the SIP/IP Core. Then, the message interworking gateway converts the SIP 200 OK to a Status response over the SSP, and sends the Status response to the WV message system. Thus, the processes end.

In Embodiment 4, the subscriber 2 of the SIP message system sends a message to the subscriber 1 of the WV message system, and the message is assumed to be large.

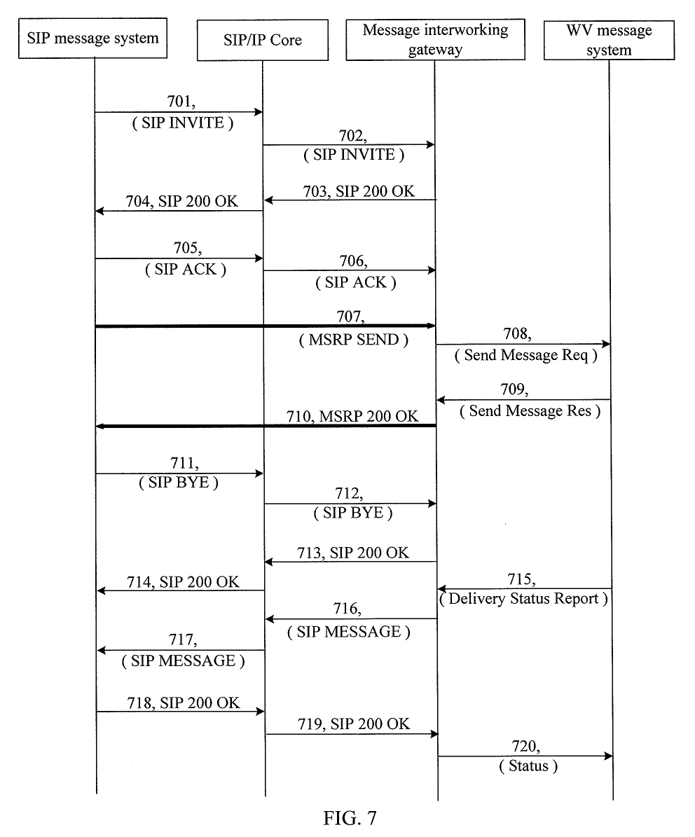

FIG. 7 is a signaling flow chart of Embodiment 4, which includes the following steps.

In Steps 701 to 702, the SIP message system sends an SIP INVITE message to the message interworking gateway through an SIP/IP Core.

In the above step, the SIP message system determines that the subscriber 1 for receiving the message belongs to the WV message system, and the message to be sent to the subscriber 1 exceeds the carrying capacity of the SIP MESSAGE. Thus, the message needs to be sent through an MSRP channel.

In addition, the SIP INVITE message carries the information such as the sender and receiver of the SIP INVITE message as well as the SDP parameters for establishing an MSRP channel.

In Steps 703 to 704, after receiving the SIP INVITE message, the message interworking gateway returns an SIP 200 OK response to the SIP message system through the SIP/IP Core.

In the above step, the SIP 200 OK response returned by the message interworking gateway contains the SDP parameters agreeing to establish the MSRP channel.

In this embodiment, the message interworking gateway is capable of establishing the MSRP channel.

In Steps 705 to 706, after receiving the SIP 200 OK response, the SIP message system returns an SIP ACK response to the message interworking gateway through the SIP/IP Core.

In Step 707, the SIP message system configures an MSRP SEND message, and sends the MSRP SEND message to the message interworking gateway.

In the above step, the MSRP SEND message carries the information such as the message content and delivery report request to be sent to the subscriber 1.

In Step 708, after receiving the MSRP SEND message, the message interworking gateway converts the MSRP SEND message to a Send Message Request over the SSP, and sends the Send Message Request to the WV message system which the subscriber 1 belongs.

In the above step, the message interworking gateway fills the information such as the message content and delivery report request contained in the MSRP SEND message to be sent to the subscriber 1 into the Send Message Request message over the SSP to convert the MSRP SEND message to a Send Message Request message over the SSP.

In Step 709, after receiving the Send Message Request, the WV message system returns a Send Message Response message over the SSP to the message interworking gateway.

In Step 710, after receiving the Send Message Response message over the SSP, the message interworking gateway returns an MSRP 200 OK response to the SIP message system through the SIP/IP Core.

In practice, if the message sent to the subscriber 1 is too large, and cannot be sent to the SIP message system through one MSRP SEND message, the message is divided into at least two MSRP SEND messages. The message interworking gateway may convert the at least two MSRP SEND messages received to one Send Message Request over the SSP, and then sends the Send Message Request to the WV system.

In Steps 711 to 712, after finishing the process of sending the MSRP SEND message, the SIP message system sends an SIP BYE requesting to disconnect the MSRP channel to the message interworking gateway through the SIP/IP Core.

In Steps 713 to 714, after receiving the SIP BYE, the message interworking gateway returns an SIP 200 OK response agreeing to disconnect the MSRP channel to the SIP message system through the SIP/IP Core.

In Step 715, on receiving a notification that the message is sent successfully to the subscriber, the WV message system sends a Deliver Status Report over the SSP to the message interworking gateway.

In the above step, if the notification that the message is sent successfully to the subscriber is received before the MSRP channel is disconnected, the WV message system may send the delivery report to the message interworking gateway through an MSRP REPORT.

In Steps 716 to 717, after receiving the Deliver Status Report over the SSP, the message interworking gateway convert the Deliver Status Report over the SSP to an SIP MESSAGE containing the delivery report notification, and then sends the SIP MESSAGE to the SIP message system through the SIP/IP Core.

In Steps 718 to 719, after receiving the SIP MESSAGE, the SIP message system returns an SIP 200 OK response received the SIP MESSAGE to the message interworking gateway through the SIP/IP Core.

In Step 720, after receiving the SIP 200 OK, the message interworking gateway returns a Status response over the SSP to the WV message system, and the processes end.

Embodiments 5 to 8 are embodiments illustrating the interworking between an email system and the SIP message system. Wherein, a subscriber 1 of the email system is set to be user1@email.com and a subscriber 2 of the SIP message system is set to be user2@simple.com.

In Embodiment 5, the subscriber 1 of the email system sends a message to the subscriber 2 of the SIP message system in the form an email, and the message is assumed to be small.

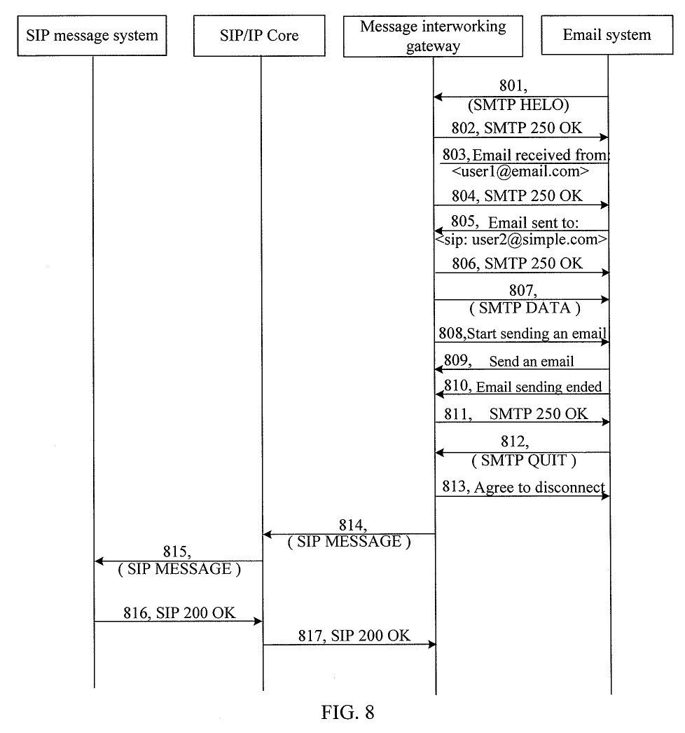

FIG. 8 is a signaling flow chart of Embodiment 5, which includes the following steps.

In Step 801, the email system sends an SMTP HELO message requesting to establish a connection to the message interworking gateway.

In the above step, the email system determines the subscriber 2 for receiving an email belongs to the SIP message system, and sends an SMTP HELO to the message interworking gateway to request to establish a connection between an email system and the message interworking gateway for sending an email.

In Steps 802 to 813, the conventional method of establishing connection between an email system and the message interworking gateway and processes of the email system sending an email to the message interworking gateway are described, so the details will not be illustrated.

In Steps 814 to 815, the message interworking gateway converts the email to an SIP MESSAGE, and sends the SIP MESSAGE to the SIP message system through an SIP/IP Core.

In the above step, after receiving the email, the message interworking gateway determines that the size of the email does not exceed the carrying capacity of the SIP MESSAGE. Thus, the SIP MESSAGE may be adopted to carry the email. The message interworking gateway fills the information such as the sender, the receiver and the message content of the email into the SIP MESSAGE to convert the email to the SIP MESSAGE.

In Steps 816 to 817, after receiving the SIP MESSAGE, the SIP message system returns an SIP 200 OK response received the SIP MESSAGE to the message interworking gateway through the SIP/IP Core.

In Embodiment 6, the subscriber 1 of the email system sends a message to the subscriber 2 of the SIP message system in form of email, and the message is assumed to be large.

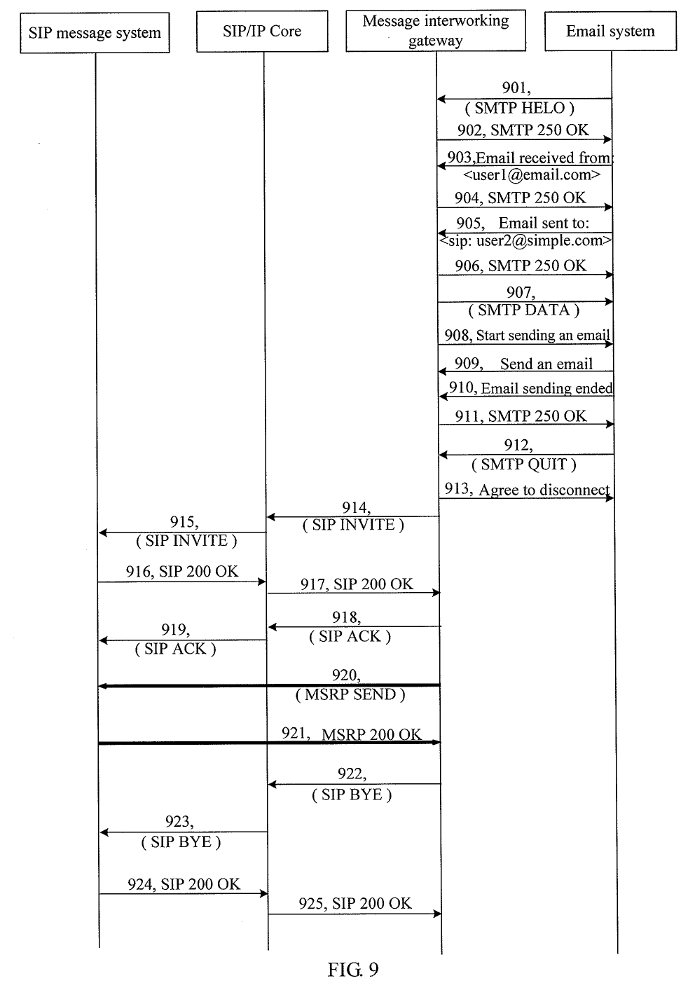

FIG. 9 is a signaling flow chart of Embodiment 6, which includes the following steps.

The description of Step 901 is identical to that of Step 801.

In Steps 902 to 913, the conventional method of establishing connection between an email system and the message interworking gateway, and processes of the email system sending an email to the message interworking gateway are described, so the details will not be illustrated.

In Steps 914 to 915, after receiving the email, the message interworking gateway converts the email to an SIP INVITE message, and forwards the SIP INVITE message to the SIP message system which the subscriber 2 belongs through an SIP/IP Core.

In the above step, the message interworking gateway determines that the size of the email exceeds the carrying capacity of the SIP MESSAGE, and thus the email needs to be sent through an MSRP channel. The message interworking gateway fills the information such as the receiver and the sender of the email into the SIP INVITE message, and the SIP INVITE message carries the SDP parameters for establishing an MSRP channel.

In Steps 916 to 917, after receiving the SIP INVITE message and a response agreeing to receive the message from the subscriber, the SIP message system forwards the SIP 200 OK response to the message interworking gateway through the SIP/IP Core.

Wherein, the SIP 200 OK carries SDP parameters negotiated by the message interworking gateway and the SIP message system. The SDP parameters are adapted for establishing MSRP channel.

In Steps 918 to 919, after receiving the SIP 200 OK, the message interworking gateway forwards an SIP ACK response to the SIP message system through the SIP/IP Core.

Till then, the process of establishing an MSRP channel between the message interworking gateway and the SIP message system is ended.

In Step 920, the message interworking gateway converts the received email to an MSRP SEND message, and sends the MSRP SNED message to the SIP message system through the established MSRP channel.

In the above step, the message interworking gateway fills the information such as the content and the content type of the email into the MSRP SEND message to convert the email to the MSRP SEND message.

In Step 921, after receiving the MSRP SEND message, the SIP message system returns an MSRP 200 OK response to the message interworking gateway through the MSRP channel.

In practice, if the email sent to the subscriber 2 is too large, and cannot be sent to the SIP message system through one MSRP SEND message, the message interworking gateway may convert the email to at least two MSRP SEND messages. Then, Steps 920 to 921 are re-performed till all the sub-emails are sent to the SIP message system.

In Steps 922 to 923, the message interworking gateway sends an SIP BYE requesting to disconnect the MSRP channel to the SIP message system through the SIP/IP Core.

In the above step, the message interworking gateway sends the SIP BYE to a home SIP message server in the SIP message system of the subscriber 2.

In Steps 924 to 925, after receiving the SIP BYE, the SIP message server sends an SIP 200 OK to the message interworking gateway through the SIP/IP Core, and the process ends.

In Embodiment 7, the subscriber 2 of the SIP message system sends a message to the subscriber 1 of the email system, and the message is assumed to be small.

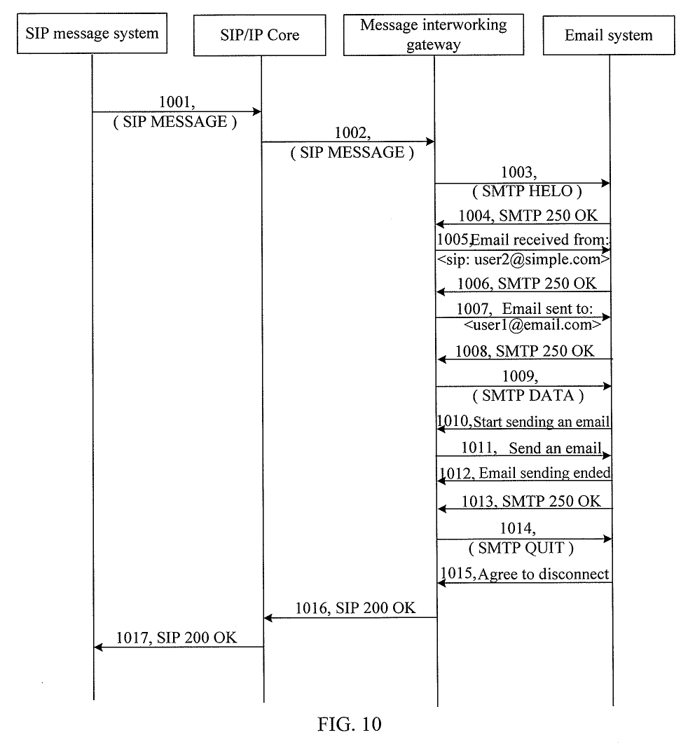

FIG. 10 is a signaling flow chart of Embodiment 7, which includes the following steps.

In Steps 1001 to 1002, the SIP message system sends an SIP MESSAGE to the message interworking gateway through an SIP/IP Core.

In the above step, the SIP message system determines the subscriber 1 for receiving an email belongs to the email system and the email may be carried by the SIP MESSAGE.

In Step 1002, after receiving the message sent by the SIP message system, the message interworking gateway converts the SIP MESSAGE to an email, and then sends an SMTP HELO to the email system.

In the above step, the message interworking gateway determines whether the received message is sent through an MSRP channel. If the received message is an SIP MESSAGE, the message interworking gateway determines that the message is not sent through the MSRP channel. The message interworking gateway fills the information such as the sender, the receiver, and the message content in the SIP MESSAGE into an email to then convert the SIP MESSAGE to an email.

In Steps 1003 to 1015, the conventional processes of the message interworking gateway sending an email to the email system are shown, so the details will not be illustrated.

In Steps 1016 to 1017, after sending an email, the message interworking gateway sends an SIP 200 OK response to the SIP message system of the subscriber 2 through the SIP/IP Core, and the processes end.

In Embodiment 8, the subscriber 2 of the SIP message system sends a message to the subscriber 1 of the email system, and the message is assumed to be large.

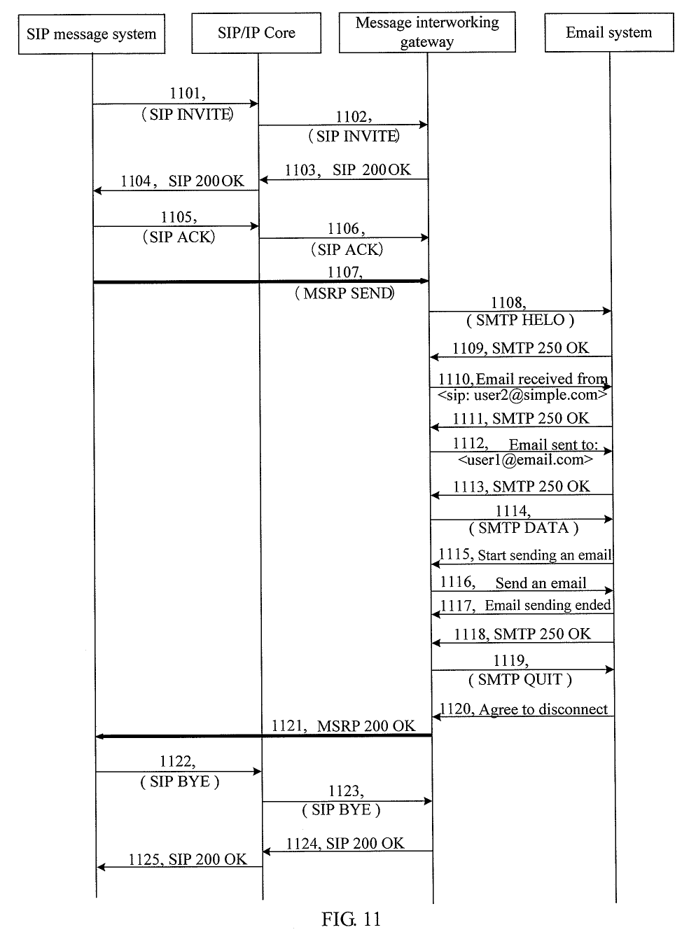

FIG. 11 is a signaling flow chart of Embodiment 8, which includes the following steps.

In Steps 1101 to 1102, the SIP message system sends an SIP INVITE message to the message interworking gateway through an SIP/IP Core.

In the above step, the SIP message system determines the subscriber 1 for receiving the message belongs to the email system and the message to be sent through the MSRP to the message interworking gateway exceeds the carrying capacity of the SIP MESSAGE. Thus, an MSRP channel needs to be established between the SIP message system and the message interworking gateway for sending the message. Therefore, the SIP message system sends an SIP INVITE message to the message interworking gateway for establishing an MSRP channel. The SIP INVITE message contains the information such as the sender and the receiver of the message as well as the SDP parameters for establishing the MSRP channel.

In Steps 1103 to 1104, after receiving the SIP INVITE message, the message interworking gateway returns an SIP 200 OK response to the SIP message system through the SIP/IP Core.

In the above step, the SIP 200 OK contains the information such as the SDP parameters for establishing the MSRP channel.

In Steps 1105 to 1106, after receiving the SIP 200 OK, the SIP message system returns an SIP ACK response to the message interworking gateway through the SIP/IP Core.

In Step 1107, the SIP message system sends an MSRP SEND message to the message interworking gateway.

In the above step, the MSRP SEND message carries the information such as the message content and delivery report request to be sent to the subscriber 1.

In Step 1107, after receiving the MSRP SEND message, the message interworking gateway converts the MSRP SEND message to an email, and sends an SMTP HELO to the email system.

In the above step, the message interworking gateway fills the information such as the sender, the receiver, and the message content in the MSRP SEND message into the email to convert the MSRP SEND message to an email.

In Steps 1108 to 1120, conventional processes of the message interworking gateway sending a message to the email system and disconnecting with the email system are described, so the details will not be illustrated.

In Step 1121, after sending the message to the email system, the message interworking gateway sends an MSRP 200 OK response to the SIP message system.

In Steps 1122 to 1123, after receiving the MSRP 200 OK response, the SIP message system sends an SIP BYE message requesting to disconnect the MSRP channel to the message interworking gateway through the SIP/IP Core.

In Steps 1124 to 1125, on receiving the SIP BYE, the message interworking gateway returns an SIP 200 OK response agreeing to disconnect the MSRP channel to the SIP message system through the SIP/IP Core, and the process end.

As the protocol between an MMS system and the SIP message system may be the same as that between an email system and the SIP message system, if the email system in the above embodiments illustrating the interworking between an email system and an SIP message system is changed to be an MMS system and the email is changed to be an MMS message, the modified embodiments are applicable to the interworking between an MMS system and an SIP message system.

A message interworking gateway will be illustrated in detail below with reference to the embodiments of the present invention.

In an embodiment of the present invention, a message interworking gateway is provided, which includes a module a module configured to establish a message session relay protocol (MSRP) channel with a session initiation protocol (SIP) message system; a module configured to receive an MSRP message sent by the SIP message system through the MSRP channel; a module configured to convert the MSRP message to a non-SIP message; and a module configured to send the non-SIP message to a non-SIP message system.

Wherein, the module for receiving the MSRP message from the SIP message system includes a module configured to receive an SIP message sent by the SIP message system, and a module configured to determine the SIP message as an MSRP message.

In the above embodiment of the present invention, the message interworking gateway further includes a module configured to receive a message requesting to disconnect the MSRP channel from the SIP message system; and a module configured to return a response message agreeing to disconnect the MSRP channel to the SIP message system.

In an embodiment of the present invention, another message interworking gateway is provided, which includes a module configured to establish an MSRP channel with an SIP message system; a module configured to receive a non-SIP message sent by a non-SIP message system; a module configured to convert the non-SIP message to an MSRP message; and a module configured to send the MSRP message to the SIP message system through the MSRP channel.

Wherein, the module configured to convert the non-SIP message to an MSRP message includes a module configured to determine whether the size of the non-SIP message exceeds the carrying capacity of an SIP MESSAGE in the SIP message system; and a module configured to convert the non-SIP message to the MSRP message when the size of the non-SIP message exceeds the carrying capacity of an SIP MESSAGE in the SIP message system.

The above message interworking gateway further includes a module configured to send a message requesting to disconnect the MSRP channel to the SIP message system; and a module configured to receive a response message agreeing to disconnect the MSRP channel from the SIP message system.

In view of the above, an interworking method for message systems and a message interworking gateway are provided according to the embodiments of the present invention. When an SIP message system sends a message to a non-SIP message system, the message is first sent to the message interworking gateway through an MSRP channel established between the SIP message system and the message interworking gateway, and then is sent to the non-SIP message system by the message interworking gateway. Further, when the non-SIP message system sends a message to the SIP message system, the message is first sent to the message interworking gateway, and then is sent to the SIP message system through the MSRP channel by the message interworking gateway. As the MSRP channel established between the SIP message system and the message interworking gateway is capable of sending large or small messages, the message interworking gateway, the interworking method and system for message systems provided by embodiments of the present invention may be adopted to achieve the interworking between the SIP message system and the non-SIP message system.

Further, for a subscriber in the message system, receiving or sending a message to another message system just like receiving or sending a message within the message system of the subscriber. Therefore, the technical solutions of the present invention may improve the experience of the subscriber.

What is claimed is:

1. An interworking method for message systems, comprising:
establishing a message session relay protocol (MSRP) channel with a session initiation protocol (SIP) message system;
receiving an MSRP message sent by the SIP message system through the MSRP channel;
converting the MSRP message to a non-SIP message; and
sending the non-SIP message to a non-SIP message system.

2. The method according to claim 1, wherein the non-SIP message system comprises at least one of the following: a wireless village (WV) message system, an email system, and a multimedia messaging service (MMS) system.

3. The method according to claim 1, wherein receiving an MSRP message sent by the SIP message system through the MSRP channel comprises:
receiving an SIP message sent by the SIP message system; and
determining that the SIP message is an MSRP message.

4. The method according to claim 1, wherein when the non-SIP message is a WV message, converting the MSRP message to the non-SIP message comprises:
filling a message content and message type information contained in the MSRP message into a Send Message Request message over a server-server protocol (SSP).

5. The method according to claim 1, wherein when the non-SIP message is one of an email and a multimedia messaging service (MMS) message, converting the MSRP message to the non-SIP message comprises:
filling a message content and message type information contained in the MSRP message into one of the email and the MMS message.

6. The method according to claim 1, wherein converting the MSRP message to the non-SIP message comprises converting at least two MSRP messages to one non-SIP message.

7. The method according to claim 1, further comprising:
receiving a response returned by the non-SIP message system; and
sending the response to the SIP message system through the MSRP channel.

8. The method according to claim 7, further comprising:
receiving a message requesting to disconnect the MSRP channel from the SIP message system; and
returning a response message agreeing to disconnect the MSRP channel to the SIP message system.

9. An interworking method for message systems, comprising:
receiving a non-SIP message sent by a non-SIP message system;
establishing a message session relay protocol (MSRP) channel with an SIP message system;
converting the non-SIP message to an MSRP message; and
sending the MSRP message to the SIP message system through the MSRP channel.

10. The method according to claim 9, wherein the non-SIP message system comprises at least one of: a wireless village (WV) message system, an email system and a multimedia messaging service (MMS) system.

11. The method according to claim 9, wherein converting the non-SIP message to the MSRP message comprises:
determining that a size of the non-SIP message exceeds a carrying capacity of an SIP MESSAGE in the SIP message system; and
converting the non-SIP message to the MSRP message.

12. The method according to claim 9, wherein converting the non-SIP message to the MSRP message comprises filling a message content and message type information contained in the non-SIP message into the MSRP message.

13. The method according to claim 9, further comprising:
receiving a response returned by the SIP message system through the MSRP channel; and
sending the response to the non-SIP message system.

14. The method according to claim 13, further comprising:
sending a message for requesting to disconnect the MSRP channel to the SIP message system; and
receiving a response message agreeing to disconnect the MSRP channel from the SIP message system.

15. A message interworking gateway, comprising:
a module configured to establish an message session relay protocol (MSRP) channel with a session initiation protocol (SIP) message system;
a module configured to receive an MSRP message sent by the SIP message system through the MSRP channel;
a module configured to convert the MSRP message to a non-SIP message; and
a module configured to send the non-SIP message to a non-SIP message system.

16. The message interworking gateway according to claim 15, wherein the module configured to receive the MSRP message sent by the SIP message system through the MSRP channel comprises:
a module configured to receive an SIP message sent by the SIP message system; and
a module configured to determine that the SIP message is an MSRP message.

17. The message interworking gateway according to claim 15, further comprising:
a module configured to receive a message requesting to disconnect the MSRP channel from the SIP message system; and
a module configured to return a response message agreeing to disconnect the MSRP channel to the SIP message system.

18. A message interworking gateway, comprising:
a module configured to establish an MSRP channel with an SIP message system;
a module configured to receive a non-SIP message sent by a non-SIP message system;
a module configured to convert the non-SIP message to an MSRP message; and
a module configured to send the MSRP message to the SIP message system through the MSRP channel.

19. The message interworking gateway according to claim 18, wherein the module configured to convert the non-SIP message to the MSRP message comprises:
a module configured to determine whether a size of the non-SIP message exceeds a carrying capacity of an SIP MESSAGE in the SIP message system; and
a module configured to convert the non-SIP message to the MSRP message when the size of the non-SIP message exceeds the carrying capacity of the SIP MESSAGE in the SIP message system.

20. The message interworking gateway according to claim 18, further comprising:
a module configured to send a message requesting to disconnect the MSRP channel to the SIP message system; and
a module configured to receive a response message agreeing to disconnect the MSRP channel from the SIP message system.
